(19) United States
(12) Patent Application Publication
(10) Pub. No.: US 2009/0327223 A1
(43) Pub. Date: Dec. 31, 2009

(54) QUERY-DRIVEN WEB PORTALS

(75) Inventors: Kaushik Chakrabarti, Redmond, WA (US); Surajit Chaudhuri, Redmond, WA (US); Venkatesh Ganti, Redmond, WA (US); Dong Xin, Redmond, WA (US); Sanjay Agrawal, Sammamish, WA (US); Arnd Christian Konig, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,469

(22) Filed: Jun. 26, 2008

(51) Int. Cl. G06F 7/06; G06F 17/30

(52) U.S. Cl. 707/3; 707/E17.108

(57) ABSTRACT

The described implementations relate to query portals. One technique analyzes search results generated by a web search engine responsive to a user search query. The technique also dynamically generates a query portal that lists the search results as well as entities identified from the search results.

### BACKGROUND

The present application relates to web or Internet searches. Searching is one of the most ubiquitous uses of the web. Millions of times everyday users access the internet and search for information by entering a search query. A web search engine processes the entered search query and returns search results including various web-pages that the search engine identifies as relevant to the search query. Many search engines are available to Internet users and competition between the search engines is fierce. Search engine algorithms are continually updated in an attempt to provide the most relevant search results.

Despite all the efforts at providing relevant search results, user satisfaction remains mixed. This may be due in part to how users enter their queries. Consider two scenarios where the same query is entered for each, but the user is seeking different results. Assume that in the first scenario the user can't remember the name of the author of his/her favorite book, “Lord of the Rings”. The user enters “Lord of the Rings” as the search query and the web search engine produces relevant search results. It is likely that one or more of the search results contains the author of the book, but the user must do further research by manually exploring the various web pages. Now, consider a second scenario where the user wants to buy a copy of “Lord of the Rings”. The user enters the same query mentioned above (Lord of the Rings) and the web search engine produces the same search results as it did in the first scenario. Again, it is likely that some of the returned search results offer opportunities for purchasing a copy of the book, but as in the first scenario, the user has to research and manually visit the web-pages to find what he/she is actually seeking. Accordingly, much room for improvement exists in what information is presented and how that information is presented to a user in response to a search query.

### SUMMARY

The described implementations relate to query portals. One technique analyzes search results generated by a web search engine responsive to a user search query. The technique also dynamically generates a query portal that lists the search results as well as entities identified from the search results.

Another implementation is manifested as a system that includes a mechanism for deriving complementary information from web search results where the web search results are generated responsive to a user search query. The system also includes a mechanism for organizing the complementary information for presentation with the web search results. The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIG. 1 illustrates an exemplary query portal generation system in accordance with some implementations of the present concepts.

FIGS. 2-5 illustrate hypothetical screenshots of exemplary query portal graphical user interfaces in accordance with some implementations of the present concepts.

FIGS. 6-10 illustrate exemplary query portal generation systems in accordance with some implementations of the present concepts.

### DETAILED DESCRIPTION

### Overview

This patent application pertains to query-driven web portals. The web portals can be thought of as query-driven in that content of the web portal can include search results for the query and complementary information derived from the search results. Hereinafter the term “query-driven web portal” is shortened to “query portal” for sake of brevity.

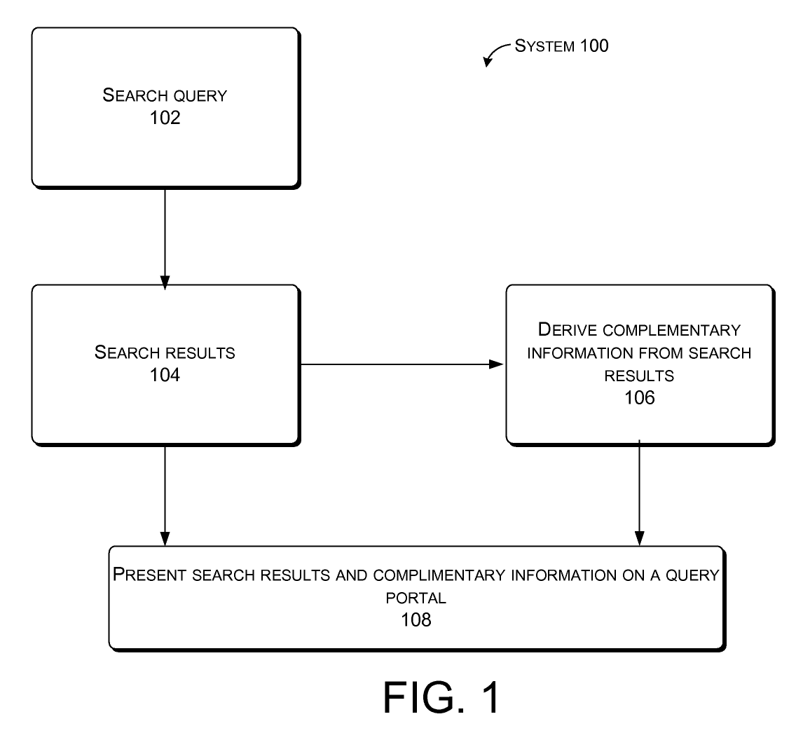

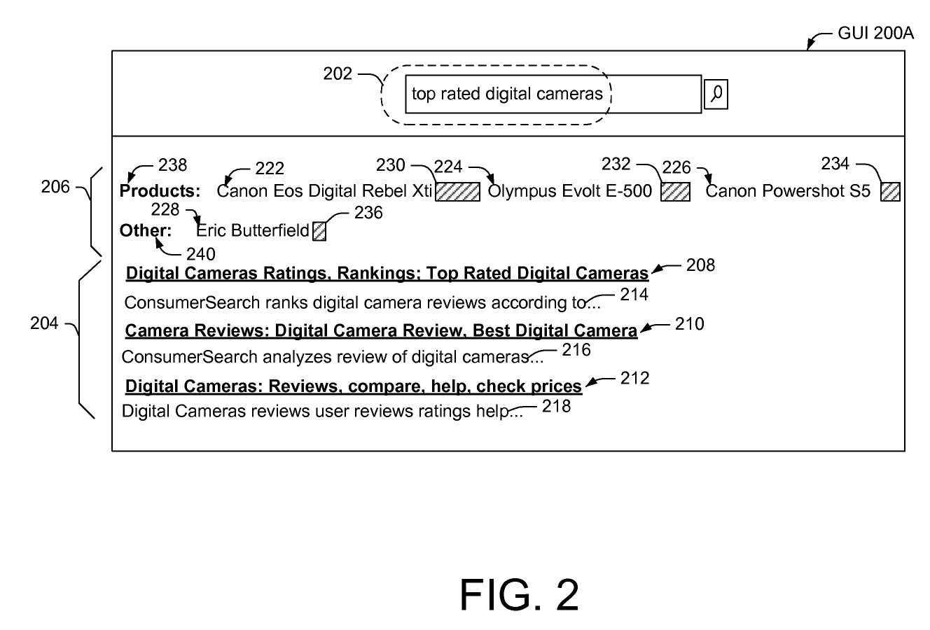

FIG. 1 offers an example of a system or technique 100 for generating query portals. In system 100, a user can enter a search query 102. Search results 104 can be generated for the search query, such as by a web search engine. The search results can include one or more ranked web pages identified by the search engine as relevant to the search query. Complementary information can be derived from the search results at 106. Complementary information can be thought of as any potentially relevant information obtained from the ranked web pages. For instance, the complementary information can relate to entities identified on the web pages. Entities can be thought of as people, places, or things that are mentioned on the web pages. The search results and the complementary information can be presented to the user in a query portal at 108. Examples of query portals are illustrated below in relation to FIGS. 2-5. In some cases, the query portal presents the complementary information in an organized manner that can aid the user in obtaining desired information. For instance, the complementary information can be presented to the user in a manner which reduces the number of user steps required to obtain desired information.

Consider an example user search query “top rated digital cameras” where a user's goal is to look at a set of digital cameras, related documents, such as reviews, and web sites with information about specific cameras. Current web search engines return a number of relevant pages. Then the user has to read through some or all of these web pages to satisfy his/her informational desires. Further, the user may have to think up and manually enter a refined search query to drill down on specific aspects of the search results. The present implementations provide the top ranked web pages and can also surface a set of relevant entities in the complementary information. In this example relevant entities might be digital cameras, accessories, organizations, people, etc.—and “focused” information relevant to individual returned entities.

Now a user can glance over the returned entities to get a quick overview of the relevant content available on the web and easily access one or more entities of interest. For example, in this case relevant entities may include several top ranked digital cameras and reviews of top ranked digital cameras. If in fact the user wanted to buy one of the cameras that opportunity can be presented for the user. Alternatively, if the user wants to review some of the top ranked cameras that opportunity can also be presented in the complementary information. In summary, the complementary information can be presented in a manner that allows the user to easily access or drill down on areas of interest. Various strategies for organizing and presenting the complementary information are described below.

### Exemplary Query Portals

FIGS. 2-5 show examples of query portal screenshots that convey the functionality offered by at least some exemplary query portals.

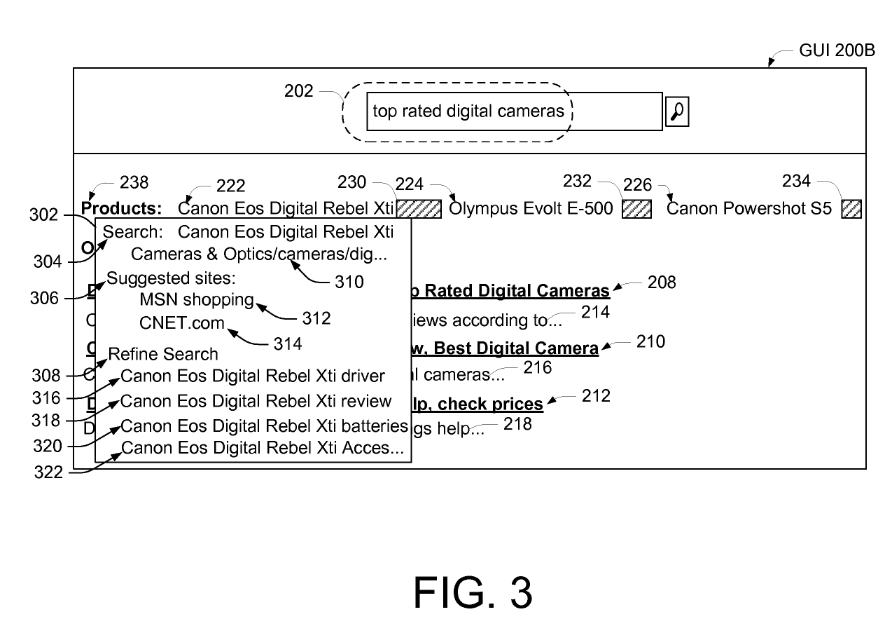

FIGS. 2-3 show exemplary query portal screenshots 200A and 200B, respectively, generated responsive to a user search query 202. In this case, the user search query 202 includes the words “top rated digital cameras”. Query portal screenshot 200A presents search results generally at 204. Complementary information is designated generally at 206 and will be described in more detail below. Accordingly, in this implementation a layout or configuration of query portal screenshot 200A can present both the search results and the complementary information.

In this case, search results 204 are identified by any number of existing search engines or search engine technologies. In this example, the search results 204 can include relevant web-pages or web-page links 208, 210, and 212 and associated snippets designated as 214, 216, and 218 respectively. Other configurations may or may not include snippets. Further, other configurations may list other information with the web-pages.

Complementary information 206 can be thought as being closely related to search results 204 and can include information obtained at least in part from leveraging the search results 204. For instance, leveraging the search results can include accessing the relevant web-pages 208-212 and analyzing content contained on the web-pages. This aspect will be addressed in more detail below, but briefly, some implementations can identify entities in the content. An entity can be thought of as a person, place or thing. Here, four entities are identified from the web-pages and are listed as: first entity 222 “Canon Eos Digital Rebel Xti”, second entity 224 is “Olympus Evolt E-500”, third entity 226 is “Canon Powershot S5”, and fourth entity 228 is “Eric Butterfield”. In this case, the first three entities are digital cameras and the fourth entity “Eric Butterfield” is a well-recognized reviewer of digital goods. While four entities are actually listed, many more may have been identified from the web-pages. So, a set of entities can be returned by analyzing the content, but only a sub-set of these entities which are relatively highly ranked may actually be surfaced or displayed on the GUI 202A.

In the illustrated configuration, entities 222-228 are given a relative relevancy ranking. In this case, a horizontal bar is used to provide the relevancy ranking. Horizontal bar 230 is associated with first entity 222, horizontal bar 232 is associated with second entity 224, horizontal bar 234 is associated with third entity 226, and horizontal bar 236 is associated with fourth entity 228. A relatively longer horizontal dimension of the horizontal bar indicates a relatively higher relevancy. For instance, first entity's horizontal bar 230 is longer than second entity's horizontal bar 232 indicating that the first entity has a relatively higher relevancy. The entity rankings may compare overall relevancy (i.e., which of the surfaced entities is most relevant) or the ranking maybe related to a sub-set of the total surfaced entities that are grouped together for organizational purposes. For instance, the relative ranking may relate to a sub-set of entities of a given type. Entity types are discussed below.

In this implementation, the entities can be organized into types of entities. For instance, in this example two entity types are shown. The first entity type is “products” designated at 238 and the second entity type is “other” designated at 240. In this case, entities 222-226 digital cameras that are listed as product type entities, while entity 228 “Eric Butterfield” is listed as in the other type 240. Entity types are not limited to the number or quantity illustrated here. Discussion relating to the selection of entity types is included below, but briefly, entity types can be another organizational tool for the user. Suppose that the reader entered the search query so that he/she could go and look at the specifications of top rated digital cameras. In such a case, the “products” entity type 238 lists the top rated cameras and the user can drill down on any one of those cameras using query portal features described below. Consider alternatively that the user instead entered the search query interested in reading reviews about top rated cameras. In such a case the “other” entity type 240 lists reviewer Eric Butterfield. If the user wants to read reviews by Eric Butterfield, then the additional information enables that option as should become apparent from the description below.

FIG. 3 shows how another feature of GUI 200B that allows a user to find out more information about a listed entity. In the illustrated case, assume the user was interested in entity 222 “Canon Eos Digital Rebel Xti”. In this configuration the user can hover his/her cursor over “Canon Eos Digital Rebel Xti”, entity 222, to produce a drop down menu 302. The drop down menu includes more information about the entity “Canon EOS Digital Rebel Xt”. For instance, in this case drop down menu 302 includes a set of tabs 304, 306, and 308 that offer additional functionality related to the selected entity.

In this case, the set of tabs—include web search query tab 304, suggested sites tab 306, and refine search tab 308. A user can click on web search query tab 304 to conduct a search specifically directed to entity 222. Further, listed at 310, under the web search query tab 304, is information known about the entity that can be utilized in formulating the search criteria of web search query tab 304. For instance, information 310 indicates that entity 222 is a product that falls within cameras & optics in the group cameras, sub-group digital cameras, etc. Thus, the search tab offers a search query that is generated for the user and which is directed to the entity. To summarize, if the user is interested in entity 222, then the search tab offers a query to the user that is directed to the entity. The user can simply click on the search tab to have the entity search conducted.

The suggested sites tab 306 offers an MSN shopping site 312, and a CNET.com site 314 relevant to entity 222. For instance the suggested sites 312, 314 may be sites that offer the entity for sale and/or contain significant amounts of information about the entity.

The refine search tab 308 allows the user to refine the search toward pre-populated variations of the selected entity 222. In this case, the refine search tab includes an option to refine the search to “Canon Eos Digital Rebel Xti driver” at 316 “Canon Eos Digital Rebel Xti review” at 318, “Canon Eos Digital Rebel Xti batteries” at 320 and “Canon Eos Digital Rebel Xti Accessories at 322. The user can simply click on a desired refined search and the search is automatically conducted for the user.

In summary, tabs 304-308 exploit the information 310 that entity “Canon EOS Digital Rebel Xt” 222 is a digital camera, as displayed by the Category (Cameras & Optics|cameras|digital cameras). Suggested MSN Shopping site 312 and CNET.com site 314 are web sites with a significant amount of relevant information for digital cameras. Similarly, more specific information about Canon EOS Digital Rebel Xt on the web such as drivers, reviews, software, batteries and accessories may all be relevant to users depending on their information desires as available under the refine search tab 308. A user may then choose to search for the relevant information. Each of these can now be issued as a new web search query thus effectively exploiting the web search engine functionality. Similar drop down menus can be generated for the other entities. In some implementations, entities within an entity type can share a given configuration. For instance, drop down menus for entities 224 and 226 can utilize the drop down configuration described above, but directed to the specific entities. A drop down for entity Eric Butterfield 228 may be configured differently. For instance, the categories for entity 228 might be reviews and qualifications. So for example, the user could quickly pick an Eric Butterfield review of a specific product or could see his qualifications to learn more about whether they want to read his reviews.

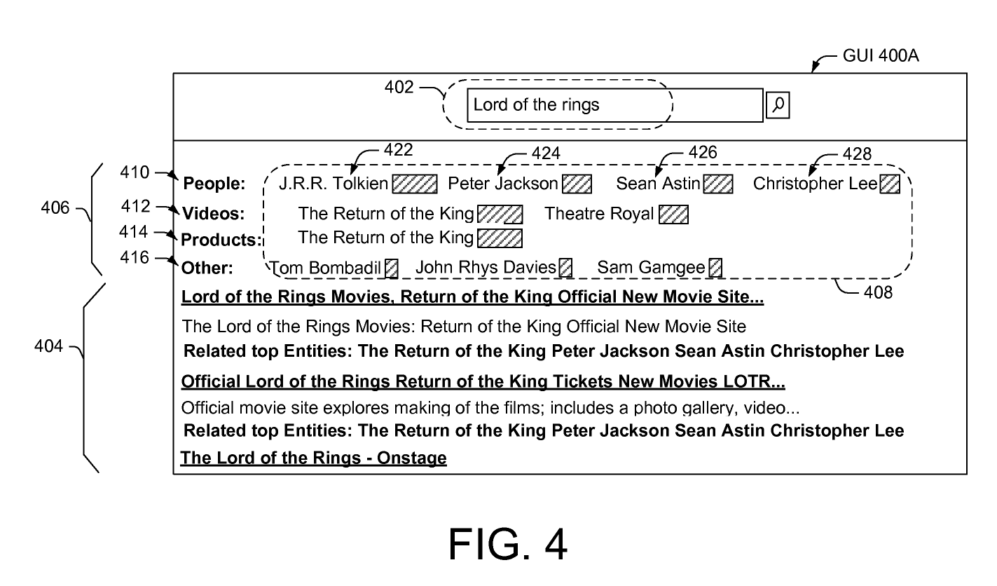

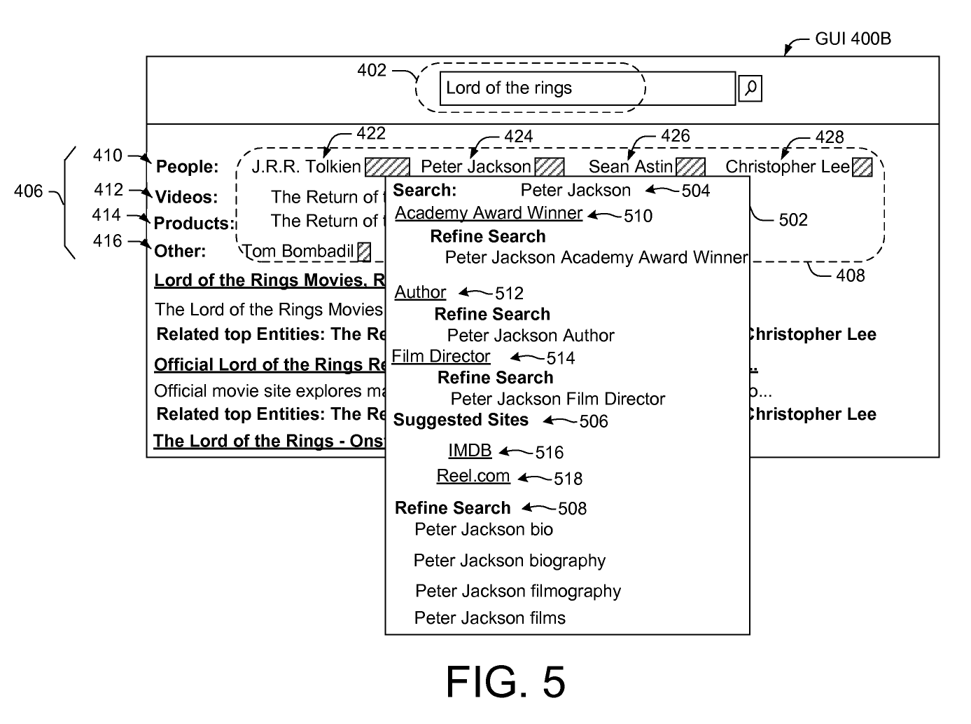

FIGS. 4-5 show another exemplary GUI 400A, 400B respectively, generated responsive to a user search query “lord of the rings” at 402. In this case, the search results are shown at 404 and the complementary information is shown at 406. The complementary information 406 relates to entities 408 obtained from search results 404. In this case, entities 408 are organized in several ways. First, the entities 408 are organized according to entity type. Four entity types are listed in this example; people 410, videos 412, products 414, and other 416. The relevant entities (i.e., people) within the entity type “people” 410 tend to be actors, directors, etc., with J. R. R. Tolkien listed at 422, Peter Jackson listed at 424, Sean Astin listed at 426, and Christopher Lee listed at 428.

Assume for purposes of explanation that the user entered the search query 402 “Lord of the Rings” because the user is interested in people involved with making Lord of the Rings. In this scenario, the entity type “people” 410 conveniently organizes relevant information for the user. So for instance, assume that the user reviews the listed entities (i.e., people) and is interested in Peter Jackson 424.

The user can select entity Peter Jackson 424 to see a drop down menu 502 (FIG. 5) of more options related to Peter Jackson. In this case, drop down menu 502 contains three tabs: a search tab 504 directed to Peter Jackson, a suggested sites tab 506, and a refine search tab 508. Within the search tab 504, the user is offered three categories relating to Peter Jackson: an academy award winner category 510, an author category 512, and a film director category 514.

If the user is interested in more information about Peter Jackson the author, then the user can simply click on “refine search” in the author category 512. If the user is interested in visiting a web-site about directors and authors, then the user can click on one of the sites listed under suggested sites. In this case, the two listed sites are IMDB.com at 516 and Reel.com at 518. (These are examples of two web-sites that are potentially related to directors and authors). Similarly, if the user wants to know more about a specific aspect of Peter Jackson, then the user can select one of the listed categories under refine search tab 508.

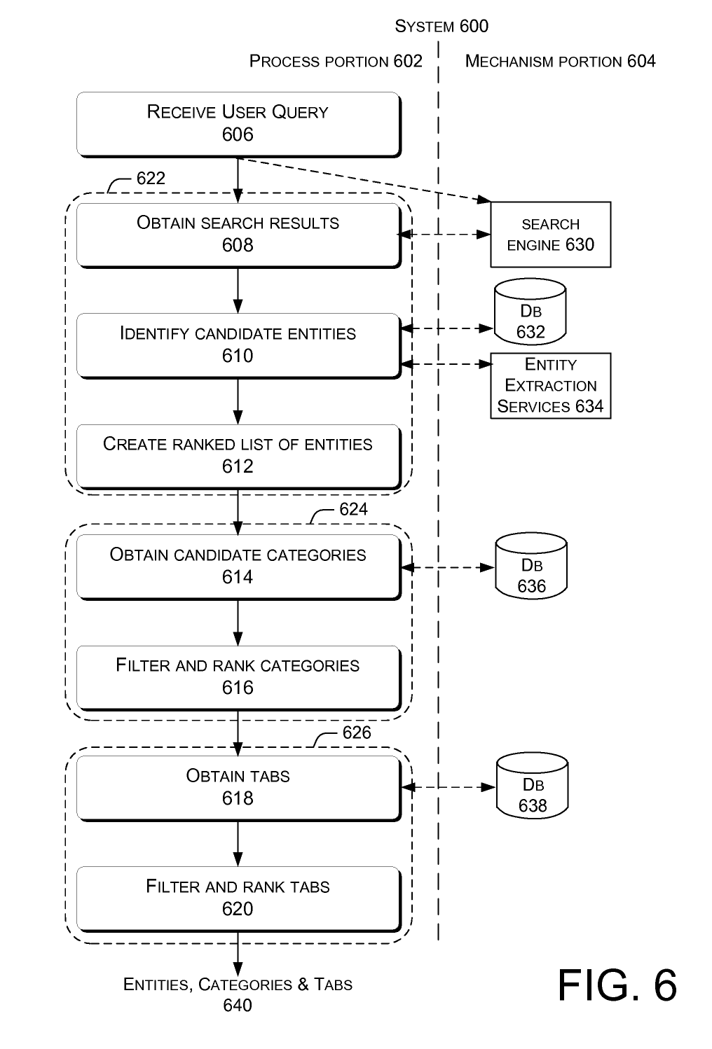

FIGS. 2-5 provide examples of how complementary information can be presented to the user. These examples have not provided much detail about how the complementary information can be obtained and processed. FIGS. 6-9 provide examples of implementations for obtaining and processing the complementary information.

### Exemplary Query Portal Architecture

FIGS. 6-9 illustrate exemplary architectures for implementing query portal functionalities.

FIG. 6 shows an exemplary architecture of a query portal system 600. For discussion purposes FIG. 6 is divided into two portions; a technique portion 602 on the left side of the drawing and a mechanism portion 604 on the right side of the drawing. The technique portion 602 is explained in the context of eight process blocks 606, 608, 610, 612, 614, 61 6, 618, and 620. These eight process blocks can serve to produce the entities, categories and tabs described above in relation to FIGS. 2-5. In this configuration, process blocks 608-612 relate generally to entities as indicated at 622, process blocks 614-616 relate generally to categories as indicated at 624, and process blocks 618-620 relate generally to tabs as indicated at 626. Mechanism portion 604 offers examples of mechanisms that can be utilized for accomplishing the technique portion in some implementations.

Initially, at 606 a user search query (hereinafter, “query”) is received. For instance, the user could enter the query into a graphical user interface (GUI) dialog box. The query can be processed by a web search engine (hereinafter, “search engine”) 630 to generate corresponding ranked search results. The search engine's algorithm(s) can identify and rank relevant web-pages which become the search results. The search results can include web-pages (or links to the web-pages). In some cases, the search results can also include snippets generated by the search engine about the web-pages. The web-pages, documents from the web-pages, web-page titles and/or snippets as well as any other web-page content may be collectively termed herein as the “search results”. The present architecture can leverage existing search engine technologies to generate the ranked search results rather than designing a competing technology.

At 608 the technique obtains the search results. In the present example, the search results can be obtained from search engine 630.

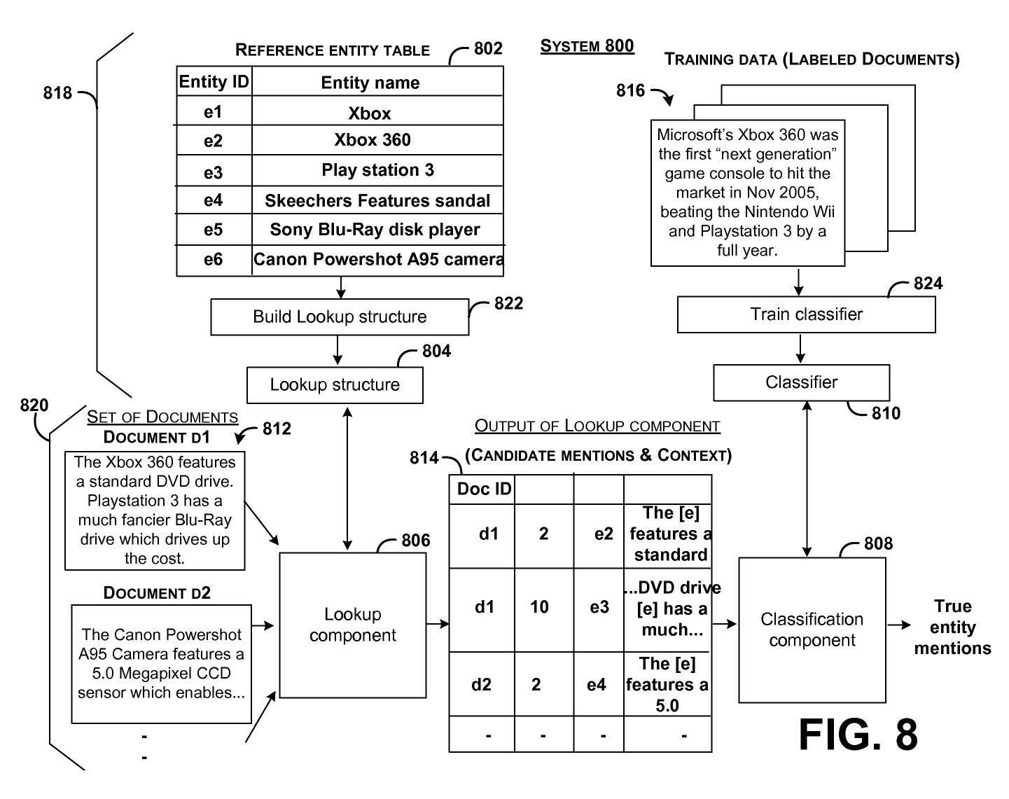

At 610 the technique identifies candidate entities from the search results. For instance, the technique can process documents from the web-pages and/or the snippets to identify candidate entities in the search results; this process can be termed “entity extraction”. Briefly, an entity can be a word or phrase that matches an entity in an entity database or dictionary. The term “candidate entity” is used at this point because subsequent processing can be performed to ensure that the candidate entities are in fact true mentions of entities. For example, a document can contain the phrase “pretty woman” which can be identified as a candidate entity. However, in one scenario, the document may be a review of a camera that discusses photographs of a pretty woman. In another scenario, the document can be a review of the movie Pretty Woman. In both scenarios the phrase pretty woman can be detected as a candidate mention, buy only in the later scenario is the phrase verified as a true mention of an entity. This process is discussed below in relation to FIG. 8.

In some cases, entity extraction can be performed on web-pages or documents from web-pages in advance. For instance, offline, entity extraction can be performed on web-page documents. The document's entities can then be stored in a database 632.

In some cases, entity extraction services 634 can be employed to accomplish entity identification. Briefly, examples of entity extraction techniques can include machine learning and look up driven extractor services. Entity extraction services 634 can access document information and take a snapshot of this information. The entity extractor services can extract entities from the document information and store the entities in an entity database 632. If the same web-page document is subsequently returned in the search results then the corresponding web-page document's entities can be obtained from the database. Processing delays at query time can be lessened by accessing the database 632 when compared to performing entity extraction on the fly. Of course, search results that are not in the database 632 can be processed for entity extraction at query time. For instance, any web-page documents that have been updated since the preprocessing can be processed at query time. Further, as mentioned above the search results may contain snippets that are generated dynamically by the search engine while searching the query and as such are not available for preprocessing. Thus, the snippets are not available before the query and can be processed for entity extraction at query time. Further, even if the entities from a web-page document are available in entity database 632 the document may have been changed in the interim and thus entity extraction can be performed at query time.

At 612 the technique creates a ranked list of entities. In one configuration, entities extracted from the search results are aggregated, filtered and ranked to create the ranked list of entities to be returned to the user in the query portal. During this ranking and filtering process, the technique can consider various features to score the relevance of an entity. In one case, examples of features that can be utilized for scoring are (i) rank of documents in which an entity appears, (ii) number of times an entity occurs within each document, (iii) total number of documents an entity appears in, (iv) closeness of keywords in the user query to each of the occurrences of an entity, among others, (v) occurrence of entity in one or more snippets. In one implementation, based on the computed relevance score, the technique can prune the set of entities based on a threshold and generate a ranked list of final entities to be surfaced to the user on the query portal. In some cases, the threshold can be established offline using learning data.

At 614 the technique obtains candidate categories. Some implementations generate a database of category listings 636 offline to look up interesting categories for each entity in the ranked entity list obtained at 612.

At 616 the technique filters and ranks categories. The database of category listings 636 can include a relative importance of a category for a given entity. The relative importance of a category for an individual entity can be generated by looking at the frequency of the entity and category combination. The relative importance of a category for individual entities can be used to filter and rank various categories across entities. Relevant categories can be surfaced corresponding to the user query by applying this process across most or all of the ranked entities.

At 618 the process generates candidate tabs (as mentioned above tabs can offer the user further query suggestions). In some implementations candidate tabs can be generated that correspond to each entity/category combination that is being surfaced. One technique can generate the tabs to provide two options for the user; suggested web-sites and query suggestions. Suggested web sites for an entity category can correspond to a set of web sites that can be considered as relatively highly relevant for that specific entity category. For example, for autos, a suggested web-site might be http://autos.msn.com. Some implementations also provide a link to issue a web search by using entity and category keywords. In some cases, tab generation can be performed in advance for entities of database 632 and categories of database of category listings 636. These tabs can be stored in a tab database 638 until query time.

At 620 the technique filters and ranks the tabs. In a similar fashion to the filtering and ranking processes described above, filtering and ranking mechanisms can be applied to tab suggestions for each entity and/or category to determine the specific links to surface. This process is described in more detail below under the heading “Web Site and Query Generation”.

In some implementations, the front end of the query portal can be developed using ASP.net web technologies. These technologies provide a mechanism for the user to enter search queries and to display the ranked and categorized list of entities along with query suggestions in addition to the search results as described above. Some of these implementations use SQL Server to store and look up the following information: (i) entities extracted offline from document body and title; (ii) categories for each entity; (iii) tabs based on query logs for an entity category.

To summarize, the techniques described in relation to process blocks 606-620 can produce the entities, categories and tabs 640 contained in the complementary information described above in relation to FIGS. 2-5. Some of the above examples utilize preprocessing in some instances to speed query portal generation at query time. However, other implementations may operate without preprocessing. The entities, entity types, entity categories, and tabs described above offer an example of how complementary information can be organized to make it more useful to the user. Further, the complementary information can be presented in an organized manner that facilitates the user drilling down on specific aspects of the complementary information.

The order in which technique 602 is described is not intended to be construed as a limitation and any number of the described blocks can be combined in any order to implement the technique or an alternate technique. Furthermore, the technique can be implemented in any suitable hardware, software, firmware, or combination thereof such that a computing device can implement the technique. In one case, the technique is stored on a computer-readable storage media as a set of instructions such that execution by a computing device causes the computing device to perform the technique.

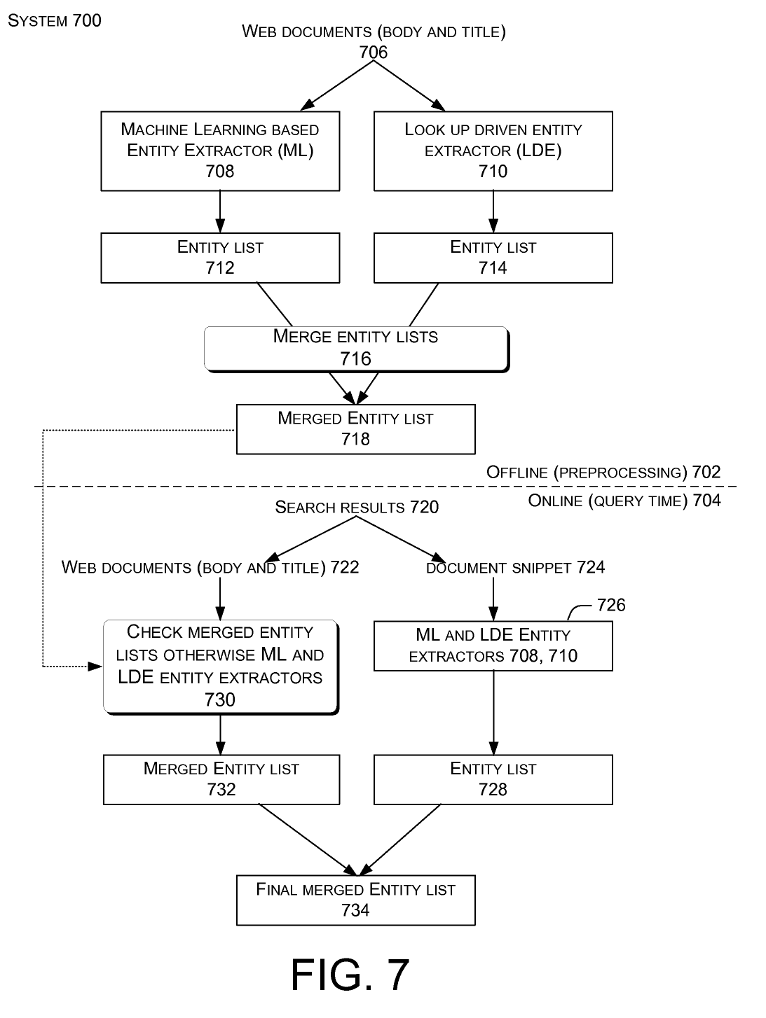

FIG. 7 shows options for identifying candidate entities as discussed above in relation to technique 610. FIG. 7 includes technique or system 700 that for discussion purposes is separated into an offline or pre-processing phase 702 and an online or query phase 704. Beginning in the offline phase the technique obtains web-documents 706. These web documents can be any random documents available on the web or a sub-set of the available documents. In some instances, the web documents can include the document body and a title of the document. Entity extraction can be performed on the web documents by an entity extractor service 634 (FIG. 6). In this case, entity extractor services can be performed by one or both of a machine learning based (ML) entity extractor 708 and a look up driven (LDE) entity extractor 710. ML entity extractor 708 can perform entity extraction to generate an entity list 712. Similarly, LDE entity extractor 710 can perform entity extraction to generate an entity list 714. These two entity lists 712, 714 can be merged at 716 to generate a merged entity list 718. This merged entity list can be stored in entity database 632 (FIG. 6).

In online phase 704, search results 720 can be processed for entity extraction. In this case, the web-pages of the search results can be separated into portions that tend to be pre-existing such as the document body and title 722 and those portions that tend to be dynamic, such as snippets 724.

One or both of ML entity extractor 708 and LDE entity extractor 710 can be utilized at 726 to extract entities from the dynamic snippets 724 to produce an entity list 728.

At 730, the pre-existing document body and title 722 can be checked against database 632 (FIG. 6) to see if a merged entity list 718 (generated during offline phase 702) for an identical version of the document already exists in the database. If an entity list is not already available, then the document body and title can be processed by one or both ML entity extractor 708 and LDE entity extractor 710 to extract the entities into an entity list in similar fashion to block 726. In either scenario, an entity list 732 is produced. In summary, entity list 732 may be identical to merged entity list 718 where the document was pre-processed offline. Entity list 728 from the dynamic portions of the document and entity list 732 from the static portions of the document are merged to form the final merged entity list 734 for the document.

### Entity Extraction

FIG. 8 shows a system 800 for accomplishing entity extraction for enabling query portal generation. System 800 includes a reference entity table 802, a lookup structure 804, a lookup component 806, a classification component 808, a classifier 810, a set of documents 812, output of the lookup component 814, and training data 816. For discussion purposes, system 800 is divided into a preprocessing phase 818 and an extraction phase 820.

System 800 can provide an ability to recognize mentions of named entities like names of people, products, locations, etc. from web pages. For example, given a document d1 in document set 812, system 800 can identify the mentions of product names “Xbox 360” and “PlayStation 3” starting at (word) positions 2 and 10 respectively. In this implementation, the entity extractor can offer one or more of the following potentially desirable properties of relatively high precision, relatively fast extraction and relatively high recall. Relatively high precision means that the returned mentions should indeed be valid entities of the labeled type. Relatively fast extraction means that the extraction should be fast so that it can be done on a web scale. Relatively high recall means that the extraction should not miss too many valid mentions.

One implementation can utilize commercial software to assist with named entity extraction. Leading approaches primarily rely on machine learning and natural language techniques in order to identify various types of entities in documents (e.g., people names, locations, products). These techniques can simultaneously recognize entities and the positions where the entities occur in documents. These techniques can first recognize that the sequence of words “Xbox 360” is a product (by applying language grammars and machine learning models over the parsed sentence context), and then return the word position at which the product was mentioned. These approaches tend to be relatively slow when applied to web-scale extraction.

In many scenarios a lot of domains exist where large, fairly complete lists of entities are available. For example, a list of famous people is available from the Wikipedia and Encarta web-sites. Similarly, a list of products is available from online shopping catalogs like the MSN Shopping catalog web-site. In another example, a list of geographic locations is available from the Encarta web-site and a list of celebrities from the IMDB web-site. Still, another example is a list of computer science researchers from the ACM web-site and DBLP web-site and so on. The present discussion refers to these lists as “entity reference sets” or “entity dictionaries”. In such domains, for an entity mention to be considered relevant, the corresponding entity occurs in a reference set. In such cases, the present concepts include an entity extraction architecture, referred to as “lookup driven extraction” (LDE) that can potentially satisfy the three potentially desirable properties listed above. FIG. 8 illustrates an exemplary architecture of LDE. The LDE can involve the preprocessing phase 818 and an extraction phase 820 mentioned above.

Preprocessing phase: During the preprocessing phase 818, the system can populate reference entity table 802. The reference entity table serves to associate an entity with an entity ID. Use of entity IDs can be more convenient for the remainder of the process. Next, the system can take the contents of reference entity table 802 as input and can build lookup structure 804 as indicated at 822. The lookup structure 804 can be subsequently used during the extraction phase 820. At 824, system 800 can also train classifier 810. As with the lookup structure 804, the classifier can be used during the extraction phase 820. The entity classifier 810 is described further below under the heading “Entity Categorization”.

Extraction phase: During the extraction phase 820, system 800 can take a set of documents as input and can return all mentions of the entities in the reference set in those documents. In the illustrated configuration this phase involves lookup component 806 and classification component 808. At the lookup stage the lookup component 806 can return all mentions of any entity in the reference table 802 in the given documents 812. The lookup component can also return the context of each of those mentions. The output of the lookup component 814 illustrates the lookup components output for documents d1 and d2 of document set 812. The output 814 references which documents an entity appears and in what position in the document as well as a context in which the entity appears. This information can be utilized by the classifier 810 as described below.

Potentially, not all the mentions returned by the lookup component 806 are true mentions. For example, consider the two sentences “Will Smith & Sons pharmacy be open on Sundays?” and “Will Smith acted in the movie Men in Black.” Suppose the reference entity table 802 contains the name “Will Smith” then lookup component 806 will recognize Will Smith in the above two sentences as candidate entities. However, the mention in the first sentence is not a true mention. The second component of the extraction phase, namely, the classification component 808, can take the mentions and contexts returned by the lookup component 806 (evidenced as output of lookup component at 814) and further analyze the output 814 to identify the true mentions. For example, based on the context in which “Will Smith” occurs, classifier 810 may then mark the occurrence in the second sentence as a person entity while ignoring the occurrence in the first sentence.

The discussion now relates to specific implementations of LDE. The techniques developed for solving the multi-pattern matching problem may be applied to extract the entities and their context from documents. A classical solution to this problem is the Aho-Corasick algorithm, which identifies all locations where patterns (in this case entities) from a given set (in this case, entity reference set) occur. In this implementation, during the pre-processing phase 818, this implementation can take the reference entity table 802 as input and build the Aho-Corasick trie. During the extraction phase 820, the technique can identify the candidate mentions and contexts from each document by running the Aho-Corasick algorithm on the document.

### Approximate Match

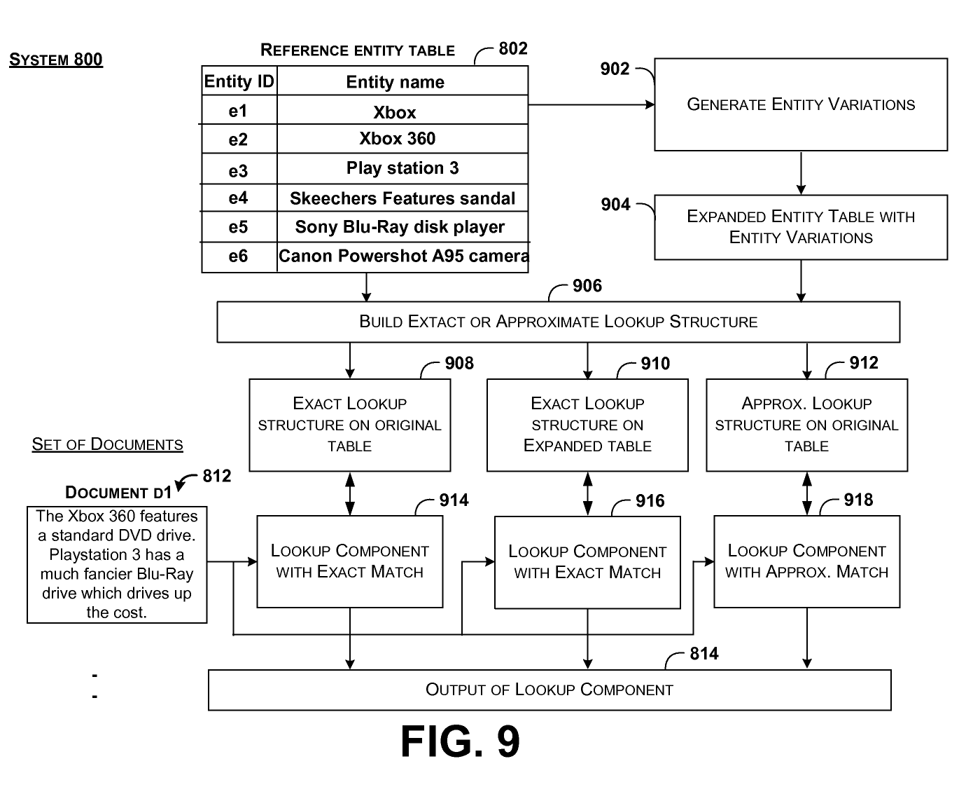

FIG. 9 expands upon the matching techniques introduced in relation to system 800 of FIG. 8. Besides the exact match solution provided by Aho-Corasick algorithm, the present entity extraction can also support approximate match solutions. For example, in an approximate match scenario, mentions in documents 812 may not be exactly the same as those in the reference entity table 802 (but refer to the same entities).

FIG. 9 illustrates several techniques for enhancing reference entity table 802 or other entity dictionaries. In this case, reference entity table 802 can be used to generate entity variations at 902. An expanded entity table with entity variations can be created at 904 utilizing these or other techniques. An extractor approximate lookup structure can be built at 906 from reference entity table 802 and the expanded entity table 904.

Three matching semantics for approximate match are offered here. First, synonym based matching where a document mention is a synonym of the corresponding reference entity. Second, distance based matching where a document mention is slightly different (within certain distance thresholds) from the corresponding reference entity. Third, subset-fingerprint based matching where a document mention contains the subset-fingerprint of the corresponding reference entity.

For instance, given a reference entity “Canon eos digital rebel XTi digital camera”, the document mention “Canon eos 400d digital camera” is a synonym based matching since “digital rebel XTi” and “400d” are synonyms under the context of “canon digital camera”. Similarly, the document mention “Canon eos digital rebel XTi camera” is a valid distance based matching for most distance functions (e.g., jaccard, string edit) and reasonable threshold. Also, a document mention “canon rebel xti” is a subset-fingerprint based matching since the subset “rebel xti” can uniquely identify the entity “Canon eos digital rebel XTi digital camera”.

Three techniques are illustrated at 908, 910, and 912. At 908 the technique builds an exact lookup structure based on original reference entity table 802. At 910 the technique builds an exact lookup structure based on expanded entity table 904. At 912 the techniques builds an approximate look up structure on original reference entity table 802.

Lookup component 806 (FIG. 8) can reference one of the lookup structures 908-912 to identify candidate matches in document 812 in output of lookup component 814. For instance, the lookup component can utilize exact match at 914 with exact lookup structure based on original reference entity table 908. The lookup component can also utilize exact match at 916 with exact lookup structure based on expanded entity table 904. Further, the lookup component can utilize approximate match at 918 with original reference entity table 802.

Examples of two implementations of interfaces for approximate match LDE are provided below. In the first implementation, the technique can generate most or all possible variations of given reference entities and apply the Aho-Corasick algorithm to the generated variation list. This is possible for synonym based matching and subset-fingerprint based matching. The second implementation utilizes fuzzy lookup techniques to efficiently identify mentions which are within a distance threshold from some reference entities. This approach can be applicable to the distance based match.

### Entity Categorization

Motivation: Identifying entity-candidates using lookup-driven extraction may not always provide adequate results when applied to the query portal generation scenario. One reason for potential inadequacy is that the phrases in the entity corpus may, in some cases, refer to different entities and in some cases may not refer to what are considered as entities. Consider the following examples which can serve to further illustrate this point.

The first example involves the entity-phrase “Earl Gray”. The entity-phrase “Earl Gray” can refer both to the person as well as the tea by the same name. Since both of these are of different category (product vs. person) they would be treated differently by the subsequent processing. Moreover, any aggregation over occurrences of an entity done as part of entity ranking tends to produce better results where the technique is able to distinguish between both of these occurrences.

The entity-phrase “Pretty woman” serves as another example that may refer to the movie of the same name (which can be considered an entity) or may not refer to a specific entity at all. The techniques are directed to potentially surface this entity along with the associated information in the first case, but not the second case. This issue is particularly common in the context of movie or book titles, as these are often phrases that are commonly used in text without referring to the book/movie in question.

In both of the above cases, the present techniques can detect the correct interpretation of the entity-phrase (with high likelihood) by examining the context in which the entity occurs and assigning categories to each occurrence of an entity-phrase.

Classification of entities in this context can be viewed as a text-classification task. Techniques such as support vector machine (SVM) models can be effectively employed for this purpose. Some implementations also rely on the SVM technology. Other implementations can easily incorporate other kinds of models. However, some aspects of the present discussion are potentially specific to the problem of entity categorization in relation to query portals. The next section describes these aspects and the resulting approaches.

Leveraging existing corpora: One salient characteristic of the present scenario involving query portals is the fact that a large corpus of (often manually collected) entities can be available. This large body of entity data can be used for classification. For example, consider the task of classifying occurrences of the phrase ‘Pretty Woman’ as either a movie of a non-movie. Here, the existence of movie actors in the context of each such occurrence is a potentially important feature in classification. Using these co-occurrences in a classifier can result in significant improvements in classification accuracy. The discussion below refers to these features as “co-occurrence features”.

As a consequence, some techniques can leverage features that denote the co-occurrence of an entity candidate with an entry in a specific list of known entities of a specific category (e.g., movies, actors, writers, etc.). Note that these techniques can preserve the category of the entity, which was found to co-occur with a candidate, as different combinations of categories are potentially important as co-occurrence features for different entity-types. For instance, co-occurrence with actors tends to be important for movie-classification, whereas co-occurrence with other electronics tends to be important to classify specific types of (electronic) products.

Using the LDE-infrastructure, some techniques can compute co-occurrence features when iterating over a document corpus. Experimental evidence tends to indicate that the use of co-occurrence features can result in significant improvements in classification accuracy. That said, other implementations can utilize other methods for categorizing entities into a set of candidate categories.

### Web Site and Query Tab Generation

As mentioned above some of the present techniques can surface two types of tabs per entity: (i) web site tabs and (ii) search query tabs. Each of these tabs can depend on the category to which an entity belongs.

The present techniques can identify the set of categories to which an entity belongs either automatically or by looking up the entity in a database. For example, “Michael Jordan” could either be a basketball player or a computer science researcher. These implementations can apply the techniques described above for entity categorization or use a database (such as prepared offline by automatic techniques) containing the categories to which each entity belongs.

Web Site Tabs: The present techniques can analyze query logs and web page content to understand whether or not a specific web domain is relevant to a given category of entities. For example, IMDB is highly relevant for movies, actors, directors, producers, etc. Given queries which contain actor (or movie or director) names, the techniques analyze the query log and the number of clicks per domain for each category of entities. If there is a dominating category for a domain then the techniques can associate that web site/domain with the corresponding category.

Query Tabs: The techniques can analyze the query logs again to identify refined queries per entity category. This can be illustrated with an example. For instance, consider the category of writers. If there are queries in the search query log which contain “Shakespeare novels”, “Tolkien novels”, “John Grisham novels” for a significant number (say, greater than 50 or 100) of writers then the techniques can leverage this occurrence and can operate under the premise that any writer w is associated with the query “w novels”. Thus, the techniques can generate a number of query tabs for each entity, based on its category. Each query tab is essentially a web query which will fetch more focused information about the entity. Note that any offline or online methods for generating interesting tabs—web sites or queries—can be incorporated into the illustrated system.

Continuing with the above discussion, now with reference to FIG. 5, the relevant web sites shown for actors and directors in drop down menu 502 are IMDB and Reel.com. The two web-sites are in fact germane to actors and directors and help to illustrate that the above discussed techniques generate useful complementary information. Similarly, in FIG. 5 the query tabs relevant for a film director are: bio, biography, filmography etc. as indicated generally at 508. Thus, these two examples show the dynamic nature of the query portal: entities relevant to a given query, web site and query tabs relevant to each entity can all be identified dynamically depending on the input query.

### Exemplary Operating Environment

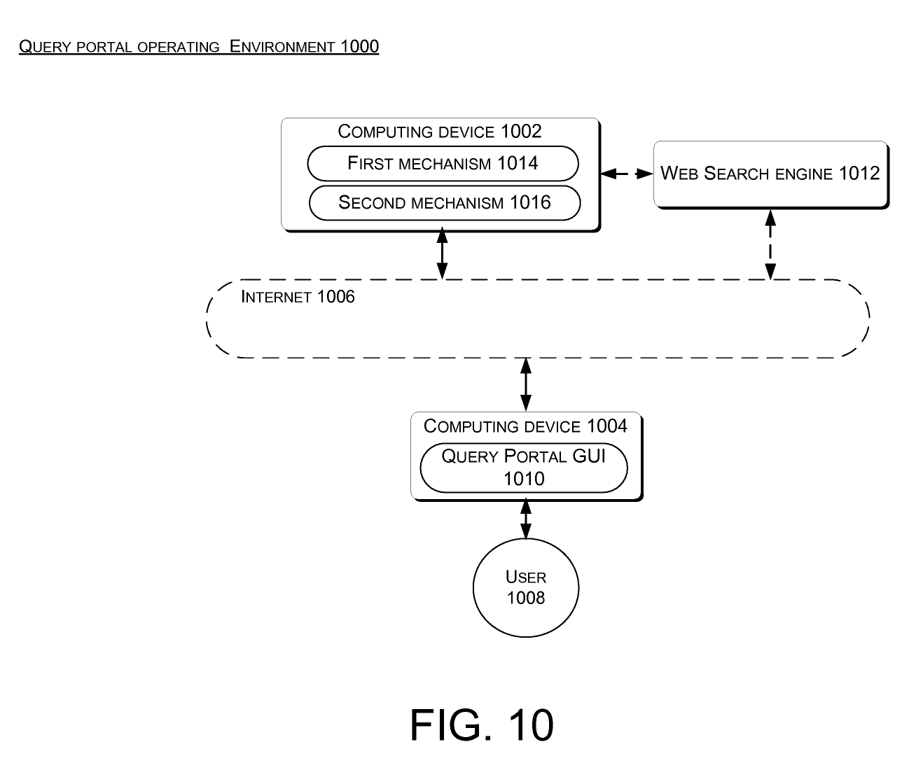

FIG. 10 shows an example of an operating environment 1000 for generating query portals. In this case, two computing devices 1002, 1004, are illustrated in operating environment 1000, but the number of computing devices is immaterial to the present discussion. Computing devices 1002 and 1004 are connected via the Internet 1006 or other network.

In this instance, a user 1008 can enter a search query on a query portal GUI 1010 displayed on computing device 1004. A web search engine 1012 can process the search query to produce search results. Computing device 1002 can include first and second mechanisms 1014, 1016.

First mechanism 1014 can derive complementary information from web search results. Second mechanism 1016 can organize the complementary information for presentation with the web search results. The second mechanism can send the organized search results and complementary information to computing device 1004 for presentation on query portal GUI 1010.

A computing device can be thought of as any digital device that is configured or configurable to communicate with other digital devices. Computing device can process instructions stored on suitable hardware, software, firmware, or combination thereof such that the computing device can implement a technique defined in the instructions. Examples of computing devices can include personal computers and other brands or types of computers, personal digital assistants, cell phones, or any other of the ever evolving types of devices.

FIG. 10 can represent a traditional server-client configuration with computing device 1002 acting as a server and computing device 1004 acting as a client. However, this is only one potential configuration. For instance, the first and second mechanisms can exist on different computing devices rather than on same device. Further, in some instances, the first and/or second mechanisms could exist on client computing device 1004.

### Conclusion

The above discussion generally relates to query portals and query portal generation. Exemplary query portals can enable users to effectively browse the web for informational queries. In order to implement the functionality, some implementations exploit large lists of entities, query logs, web content, as well as the web search engine. Further, entity extraction and categorization, and web-site and query tab generation can be performed offline using large clusters of machines so that ranking of entities, categories, and tabs can be dynamically and efficiently implemented at run time.

Although techniques, methods, devices, systems, etc., pertaining to query portals are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a mechanism for deriving complementary information from web search results, where the web search results are generated responsive to a user search query; and,
a mechanism for organizing the complementary information for presentation with the web search results.

2. The system of claim 1, wherein the mechanism for deriving is configured to extract entities from web documents prior to receiving the web search results and to determine whether the web search results include any of the entity-extracted web documents.

3. The system of claim 1, wherein the mechanism for deriving is configured to apply one or more of: synonym based matching, distance based matching, and subset-fingerprint based matching to identify candidate matches between the web search results and a dictionary of entities.

4. The system of claim 1, wherein the mechanism for deriving is configured to extract entities from the web search results.

5. The system of claim 4, wherein the mechanism for deriving is configured to extract the entities by comparing the web search results to dictionaries of entities.

6. The system of claim 4, wherein the mechanism for organizing is configured to rank the entities and include at least some relatively high ranking entities in the presentation.

7. The system of claim 4, wherein the mechanism for organizing is configured to rank the entities and to organize the ranked entities by entity type.

8. The system of claim 4, wherein the mechanism for organizing is configured to identify categories related to individual entities and to offer one or more tabs for user selection within a category.

9. The system of claim 1, wherein the mechanism for deriving and the mechanism for organizing both reside on a server computer.

10. The system of claim 1, wherein the mechanism for organizing the complementary information for presentation with the web search results is configured to cause a query portal to be generated for the presentation of the complementary information and the web search results.

11. A computer-readable storage media having instructions stored thereon that when executed by a computing device cause the computing device to perform acts, comprising:
deriving complementary information from search results produced by a search engine responsive to a user search query; and,
causing the search results and the complementary information to be displayed in a query portal such that a user can drill down through the complementary information in a broad to narrow manner.

12. The computer-readable storage media of claim 11, wherein the deriving comprises extracting complementary information in the form of entities from the search results by comparing the search results to dictionaries.

13. The computer-readable storage media of claim 11, wherein the deriving comprises extracting complementary information in the form of entities from the search results and further organizing the entities by entity type and generating categories and tabs for entities of an individual type.

14. The computer-readable storage media of claim 12, wherein the causing comprises displaying the entities by entity type and providing a drop down menu when the user selects an individual entity that offers suggested categories and tabs for the individual entity.

15. A computer-readable storage media having instructions stored thereon that when executed by a computing device cause the computing device to perform acts, comprising:
analyzing search results generated by a web search engine responsive to a user search query; and,
dynamically generating a query portal that lists the search results as well as entities identified from the search results.

16. The computer-readable storage media of claim 15, wherein the analyzing comprises identifying entities in the search results and organizing the entities by one or more of relative relevancy rank and entity type.

17. The computer-readable storage media of claim 15, wherein the analyzing comprises one of: (1) generating possible variations of given reference entities and applying an Aho-Corasick algorithm to the generated variations and (2) utilizing fuzzy lookup techniques to identify individual entities which are within a distance threshold from an individual reference entity.

18. The computer-readable storage media of claim 15, wherein the dynamically generating comprises presenting an indication of a relative relevancy rank for individual entities.

19. The computer-readable storage media of claim 15, wherein the dynamically generating comprises organizing the entities by entity type.

20. The computer-readable storage media of claim 15, wherein the dynamically generating comprises determining categories of potential interest for individual entities.
